(19) United States
(12) Patent Application Publication
(10) Pub. No.: US 2026/0170616 A1
(43) Pub. Date: Jun. 18, 2026

(54) CONDITIONAL DATA GENERATION USING LATENT CONTINUOUS CONDITIONAL RANDOM FIELD MODELS

(71) Applicant: Google LLC, Mountain View, CA (US)

(72) Inventors: Gayan Sadeep Jayasumana Hirimbura Matara Kankanamge, Houston, TX (US); Kanchana Ranasinghe, Lake Grove, NY (US); Srikumar Ramalingam, West Windsor, NJ (US); Andreas Veit, New York, NY (US); Daniel Glasner, New York, NY (US); Sanjiv Kumar, Jericho, NY (US); Ayan Chakrabarti, New York, NY (US)

(21) Appl. No.: 19/425,793

(22) Filed: Dec. 18, 2025

Related U.S. Application Data
(60) Provisional application No. 63/735,872, filed on Dec. 18, 2024.

(51) Int. Cl. G06T 5/60; G06T 5/70; G06T 11/00

(52) U.S. Cl. CPC G06T 5/60; G06T 5/70; G06T 11/00; G06T 2207/10016; G06T 2207/20081; G06T 2207/20084

(57) ABSTRACT

Methods, systems, and apparatus, including computer programs encoded on computer storage media, for generating a data item conditioned on a conditioning input. For example, the data item can be audio, video, or an image. The data item is generated across a plurality of denoising steps, with at least some of the denoising steps being performed using a conditional latent random field model.

### CROSS-REFERENCE TO RELATED APPLICATION

This application claims priority to U.S. Provisional Application No. 63/735,872, filed on Dec. 18, 2024. The disclosure of the prior application is considered part of and is incorporated by reference in the disclosure of this application.

### BACKGROUND

This specification relates to generating data, e.g., images, using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers in one or more locations that generates output data items from conditioning inputs using a latent continuous random field (CRF) model.

Generally, the conditioning input characterizes one or more desired properties for the data item, i.e., characterizes one or more properties that the final data item generated by the system should have.

Particular embodiments of the subject matter described in this specification can be implemented so as to realize one or more of the following advantages.

Latent Diffusion Models (LDMs) have been shown to produce high-quality data items, e.g., high-quality, photo-realistic images, in response to a variety of different conditioning inputs. However, LDMs require many computationally expensive inference iterations in order to denoise an initial, noisy representation into a final representation that can be accurately decoded into a final output item, e.g., an output image. Thus, the latency and computational cost incurred by these multiple costly inference iterations can restrict the applicability of LDMs.

This specification introduces LatentCRF, a continuous Conditional Random Field (CRF) model, implemented as a neural network layer, that models the spatial and semantic relationships among the latent vectors in the LDM. By replacing some or all of the computationally-intensive LDM inference iterations with the lightweight LatentCRF, the described techniques achieve a superior balance between quality, speed and diversity relative to using LDMs for all inference iterations as is done in conventional approaches. For example, the described techniques can increase inference efficiency by 33% with no loss in output quality or diversity compared to the full LDM.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example data generation system.

FIG. 2 shows an example of generating an output image.

FIG. 3 is a flow diagram of an example process for generating an output data item.

FIG. 4 is a flow diagram of an example process for updating the latent representation at a particular denoising step using the latentCRF model.

FIG. 5 is a flow diagram of an example process for training the latentCRF model.

FIG. 6 shows an example of the performance of the described techniques.

Like reference numbers and designations in the various drawings indicate like elements.

### DETAILED DESCRIPTION

This specification describes a system implemented as computer programs on one or more computers in one or more locations that generates an output data item conditioned on a conditioning input.

Generally, the conditioning input characterizes one or more desired properties for the data item, i.e., characterizes one or more properties that the final data item generated by the system should have.

The system can be configured to generate any of a variety of output data items conditioned on any of a variety of conditioning inputs.

For example, the system can be configured to generate audio data, e.g., a waveform of audio or a spectrogram, e.g., a mel-spectrogram or a spectrogram where the frequencies are in a different scale, of the audio.

In this example, the conditioning input can be text or features of text that the audio should represent, i.e., so that the system serves as a text-to-speech machine learning model that converts text or features of the text to audio data for an utterance of the text being spoken.

As another example, the conditioning input can characterize properties of a song or other piece of music, e.g., lyrics, genre, and so on, so that the system generates a piece of music that has the properties characterized by the conditioning input.

As another example, the conditioning input can specify a classification for the audio data into a class from a set of possible classes, so that the system generates audio data that belongs to the class. For example, the classes can represent types of musical instruments or other audio emitting devices, i.e., so that the system generates audio that is emitted by the corresponding class, or types of animals, i.e., so that the system generates audio that represents noises generated by the corresponding animal, and so on.

As another particular example, the data item can be an image, such that the system can perform conditional image generation by generating the intensity values of the pixels of the image.

In this particular example, the conditioning input can be a sequence of text and the output data item can be an image that describes the text, i.e., the conditioning input can be a caption for the output image.

As yet another particular example, the conditioning input can be an object detection input that specifies one or more bounding boxes and, optionally, a respective type of object that should be depicted in each bounding box.

As yet another particular example, the conditioning input can specify an object class from a plurality of object classes to which an object depicted in the output image should belong. As another example, the conditioning input can specify one or more images.

For example, the conditioning input can specify an image at a first resolution and the output data item can include the image at a second, higher resolution.

As another example, the conditioning input can specify an image and the output data item can comprise a de-noised, enhanced, stylized, or otherwise edited version of the image.

As yet another particular example, the conditioning input can specify an image including a target entity for detection, e.g., a tumor, and the output data item can comprise the image without the target entity, e.g., to facilitate detection of the target entity by comparing the images.

As yet another particular example, the conditioning input can be a segmentation that assigns each of a plurality of pixels of the output image to a category from a set of categories, e.g., that assigns to each pixel a respective one of the category.

As yet another example, the conditioning input can be a different type of structured input, e.g., a mesh or a graph that specifies properties of the image to be generated.

More generally, the conditioning input can include one or more different types of inputs of one or more different modalities, e.g., only text, only one or more images, both text and one or more images, and so on.

As yet another example, the output data item can be a video.

As a particular example, the conditioning input can include text and the output data item can be a video described by the text.

As yet another particular example, the conditioning input can include one or more images and the output data item can be a video that completes the one or images, e.g., video starting from the one or more images.

As another particular example, the conditioning input can include text and an input video, and the output data item can be an edited version of the input video that has been edited as specified by the text.

More generally, the task of generating the output data item can be any task that outputs continuous data conditioned on a conditioning input. For example, the output can be an output of a different sensor, e.g., a lidar point cloud, a radar point cloud, an electrocardiogram reading, and so on, and the conditioning input can represent the type of data that should be measured by the sensor. Where a discrete output is desired, this can be obtained, e.g., by thresholding the outputs generated by the diffusion neural network.

In some applications, the output data item can be used in a control task to control an action of a mechanical agent acting in a real-world environment to perform a mechanical task. For example, the output data item can be processed by a policy neural network of the agent to select one or more actions to be performed by the agent as part of the task. The agent may then perform the one or more actions. The output data item (e.g., image) can, for example, characterize a state of the real-world environment that is predicted to be obtained by the agent performing the one or more actions.

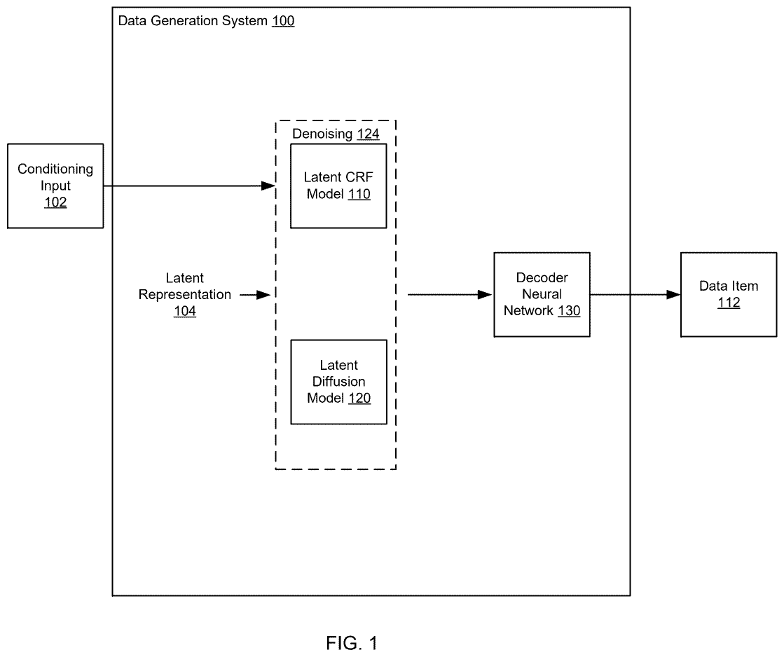

FIG. 1 is a diagram of an example data generation system 100. The data generation system 100 is an example of a system implemented as computer programs on one or more computers in one or more locations, in which the systems, components, and techniques described below can be implemented.

The system 100 obtains a conditioning input 102 and uses the conditioning input 102 to generate an output (final) data item 112 that has the one or more desired properties characterized by the conditioning input 102.

Generally, the system 100 can generate an output data item 112 using a latentCRF model 110.

More specifically, the system 100 generates the output data item 112 by performing a denoising process on a noisy representation of the output data item 112 using (i) the latentCRF model 110 while the latentCRF model is conditioned on the conditioning input 102 and, optionally, (ii) a latent diffusion model 120 while the latent diffusion model 120 is conditioned on the conditioning input 102.

The data item generated by performing the denoising process is a “latent” data item in a latent space, i.e., so that the values in the latent data item are values in a latent representation of an output data item in the output space. That is, the denoising process is performed on a latent representation of an output data item, e.g., in a latent representation of an image in the pixel space when the output is an image.

The latent space is generally lower-dimensional than the output space, allowing the denoising process to be performed in a more computationally efficient manner.

Because the output data item is generated in the latent space, the system 100 can generate the final output data item 112 in output space by processing the latent data item in the latent space (i.e., the final representation generated by performing the denoising process) using a decoder neural network 130, e.g., one that has been pre-trained in an auto-encoder framework with an encoder neural network.

During training, the system 100 can use the encoder neural network, e.g., one that has been pre-trained jointly with the decoder neural network 130 in the auto-encoder framework, to encode target data items in the output space to generate target outputs in the latent space.

In particular, to generate a data item, the system 100 obtains a conditioning input 102 characterizing a target data item.

The system 100 initializes a latent representation 104 of the target data item that includes a respective latent vector at each of a plurality of positions. For example, the latent representation 104 can be a two-dimensional representation that includes a respective latent vector at each point on a two-dimensional grid. As another example, the latent representation 104 can be a three-dimensional representation that includes a respective latent vector at each point in a three-dimensional grid. For example, the system 100 can sample the values of the latent vectors from a noise distribution, e.g., a Gaussian distribution or another appropriate distribution.

The system 100 performs a denoising process 124 by updating the latent representation 104 at each of a sequence of denoising steps.

At each of one or more particular denoising steps in the sequence, the system 100 updates the latent representation 104 at the particular denoising step by applying the latentCRF model 110 to the latent representation 104.

For example, the system 100 can use the CRF model 110 at all of the denoising steps. As another example, the system 100 can use the CRF model 110 to decrease the latency and improve the computational efficiency of generating data items using a latent diffusion model 120.

In this example, the system 100 uses the latent diffusion model 120 at some of the steps while using the CRF model 110 at one or more different steps. For example, the system 100 can use latent diffusion model 120 at a set of initial denoising steps, followed by using the CRF model 110 at one or more particular steps, and then complete the denoising process by using the latent diffusion model 120 at one or more subsequent denoising steps. In this example, the initial denoising steps can focus on high variance changes that are conditioned on the condition input 102, where large capacity models play an important role. Subsequent denoising steps can focus on realism, which the lightweight CRF model 110 with stronger inductive bias successfully replaces. The final denoising steps can touch up fine details using the latent diffusion model 120.

Because the CRF model 110 is more computationally efficient than the latent diffusion model 120, performing some of the denoising steps using the CRF model 110 instead of the latent diffusion model 120 dramatically decreases the latency and increases the computational efficiency of the denoising process.

After updating the latent representation 104 of the target data item at each of the plurality of denoising steps, the system 100 processes the latent representation 104 using the decoder neural network 130 to generate the target data item 112.

Generally, the CRF model 110 updates the latent representation 104 at a particular denoising step by determining an estimate of an updated latent representation that minimizes an energy function given the latent representation 104 as of the particular denoising step (and the conditioning input). That is, the CRF model 110 generates an updated latent representation that is an estimate of the latent representation that would minimize the energy function given the latent representation and a representation of the conditioning input 102.

Updating a latent representation using the CRF model 110 is described in more detail below.

Examples of generating representations of conditioning inputs are described in more detail below.

Examples of latent diffusion models 120 and of updating the latent representation at a given denoising step using a latent diffusion model 120 (referred to as a “diffusion neural network”) will now be described. As described above, when the latent diffusion model 120 is used, instead of using the latent diffusion model 120 at all iterations of the denoising process, the system 100 instead uses the latentCRF model 110 at one or more of the iterations, decreasing latency and increasing computational efficiency.

The diffusion neural network performs the denoising process in the latent space, e.g., in a latent space that is lower-dimensional than the output space. That is, the data items (“representations”) operated on by the diffusion neural network are latent representations and the values in the representations are learned, latent values, e.g., rather than color values when the data items are images.

Examples of such diffusion neural networks include simple diffusion and mobile diffusion.

In some implementations, when the output data item is an audio signal or an image or a video, the diffusion neural network can be a convolutional neural network, e.g., a U-Net or other architecture that maps one input of a given dimensionality to an output of the same dimensionality.

As another example, the diffusion neural network can be a Transformer neural network that processes the diffusion input through a set of self-attention layers to generate the denoising output.

As yet another example, the diffusion neural network can include both convolutional layers and self-attention layers.

The neural network can be conditioned on the conditioning input in any of a variety of ways.

As one example, the system can use an encoder neural network to generate one or more embeddings that represent the conditioning input and the diffusion neural network can include one or more cross-attention layers that each cross-attend into the one or more embeddings.

An embedding, as used in this specification, is an ordered collection of numerical values, e.g., a vector of floating point values or other types of values.

For example, when the conditioning input is text, the system can use a text encoder neural network, e.g., a Transformer neural network, to generate a fixed or variable number of text embeddings that represent the conditioning input.

When the conditioning input is an image, the system can use an image encoder neural network, e.g., a convolutional neural network or a vision Transformer neural network, to generate a set of embeddings that represent the image.

When the conditioning input is audio, the system can use, e.g., an audio encoder neural network, e.g., an audio encoder neural network that has been trained jointly with a decoder neural network as part of a neural audio codec, to generate one or more embeddings that encode the audio.

When the conditioning input is a scalar value, the system can use, e.g., an embedding matrix to map the scalar value or a one-hot representation of the scalar value to an embedding.

In some cases, the conditioning input includes multiple different types of inputs, e.g., two or more of text, images, bound values, or context embeddings.

In some of these cases, the system can generate one or more initial embeddings for each of the different types of inputs, i.e., using an appropriate encoder neural network as described above, and then process the initial embeddings for all of the different types of inputs using a Transformer encoder neural network to update each of the initial embeddings to generate a set of final embeddings. The one or more cross-attention layers within the diffusion neural network can then cross-attend into the set of final embeddings.

In others of these cases, different cross-attention layers within the diffusion neural network can cross-attend into embeddings of different types of conditioning inputs.

In yet others of these cases, the system can concatenate the initial embeddings of the different types of inputs along the sequence dimension and then the one or more cross-attention layers can cross-attend into the concatenated set of final embeddings.

As another example, the diffusion neural network can include one or more other types of neural network layers that are conditioned on the one or more embeddings. Examples of such layers include Feature-wise Linear Modulation (FILM) layers, layers with conditional gated activation functions, and so on.

As another example, the output(s) of the encoder(s) when encoding one or more of the conditioning inputs can be combined, e.g., through a weighted sum, with features of the representation of the output data item, and the combined features can be processed by the remainder of the diffusion neural network.

As yet another example, the output(s) of the encoder(s) when encoding one or more of the conditioning inputs can be concatenated with the latent representation of the output data item and the concatenation can be processed by the diffusion neural network.

The diffusion input at any given denoising step can also include data defining a noise level for the denoising step. Generally, each denoising step has a corresponding time step t and the noise level for the iteration depends on the time step. For example, the noise level can be a decreasing function of the time step t. Examples of such functions include a linear function, a cosine function, and a sigmoid function. In these cases, data identifying the noise level, the time step, or both can be embedded using an appropriate neural network, e.g., a multi-layer perceptron (MLP) and used to condition the diffusion neural network as described above for the conditioning input.

The system then updates the representation at each of a plurality of reverse diffusion steps (also referred to as “iterations” or “denoising steps”) using the conditional diffusion neural network. Each reverse diffusion step is associated with a noise level for the step. Generally, each denoising step has a corresponding time step t and the noise level for the iteration depends on the time step. For example, the noise level can be a decreasing function of the time step t. Examples of such functions include a linear function, a cosine function, and a sigmoid function. Thus, early iterations are associated with higher noise levels and later iterations are associated with lower noise levels, resulting in the diffusion neural network gradually “denoising” the representation to generate the final representation.

As part of the updating at any given step, the system generates a denoising output for the reverse diffusion step.

The system then updates the representation of the output image using the denoising output for the reverse diffusion step.

For example, the system can map the denoising output to an initial updated representation and then apply a diffusion sampler, e.g., the DDPM (Denoising Diffusion Probabilistic Model) sampler, the DDIM (Denoising Diffusion Implicit Model) sampler or another appropriate sampler, to the initial updated representation to generate an updated representation.

Optionally, after the last reverse diffusion iteration, the system can refrain from using the diffusion sampler and can instead use the initial updated representation as the updated representation.

To generate the denoising output, the system processes a first denoising input for the reverse diffusion step that includes the representation of the output image and the conditioning input using the denoising neural network to generate a first denoising output.

In some cases, the first denoising output is the denoising output. In some other cases, the system also generates one or more additional denoising outputs and then combines the additional denoising output(s) with the first denoising output through classifier free guidance, i.e., by computing a weighted sum of the denoising outputs with the weight for each denoising output being determined by a guidance weight for the classifier free guidance.

Any of the techniques described above can generate the representation of the conditioning input 102 that is operated on by the latentCRF model 110. For example, the latent diffusion model 120 can use the same representation(s) as the latentCRF model 110 or the latentCRF model 110 and the latent diffusion model 120 can use different representations generated by different encoders.

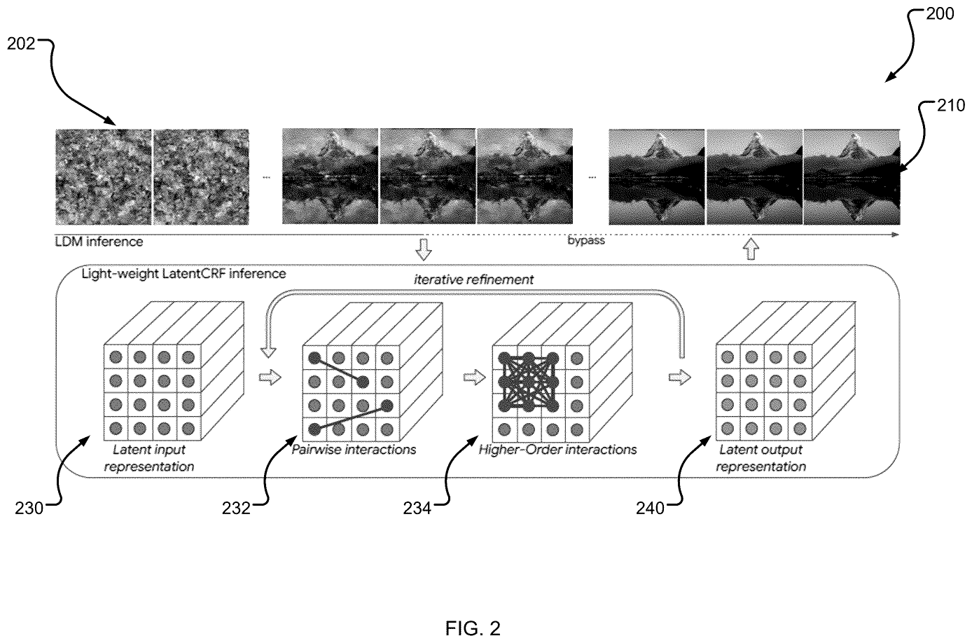

FIG. 2 shows an example 200 of generating an output image 210.

While FIG. 2 shows the representations that are being operated on as being images in the output space, i.e., in the pixel space, for ease of description, in general the representations are in the latent space and the system 100 generates the output image 210 by processing the final latent representation using the decoder neural network 130.

In particular, as shown in FIG. 2, the system 100 initializes a noisy latent representation 202. The system 100 then updates the latent representation 202 at each of a sequence of denoising steps.

For an initial set of denoising steps in the sequence, the system 100 uses the latent diffusion model 120 to update the representation. That is, at each denoising step in the initial set, the system 100 updates the representation 202 as of the denoising step using the latent diffusion model 120 as described above.

As of a particular denoising step, however, the system 100 “bypasses” using the latent diffusion model 120 and instead uses the latentCRF model 110 to update the representation 202 at the particular denoising step.

The system then continues updating the representation 202 using the latent diffusion model 120 at one or more additional representations to generate a final representation, which the system 100 then maps to the output image 210 using the decoder neural network 130.

At the particular denoising step, the system updates the representation 202 by performing iterative refinement on an input latent representation 230 (also referred to as an “estimate” in this specification), which is initialized as the representation 202 as of the particular denoising step, to generate an output latent representation 240, which serves as the updated representation for the particular denoising step.

Generally, at each iteration of the iterative refinement, the system uses the latentCRF model to generate an estimate of a latent representation (“assignment”) that has a minimum energy given the input representation as of the iteration and the conditioning input. The energy of an assignment is generally based on three components: (i) an independent component that measures the energy of each latent vector independently, (ii) a pair-wise component that measures the energy arising from pair-wise interactions between pairs of latent-vectors, and (iii) a higher-order component that measures the energy arising from higher-order interactions in cliques of latent vectors that each include more than two latent vectors. That is, the energy E of an assignment y can be expressed as:

$$E ( y \vert x ) = {\sum }_{i} d ( {𝓎}_{i} , {𝓍}_{i} ) + {\sum }_{i , j} {f}_{ij} ( {𝓎}_{i} , {𝓎}_{j} , c ) + {\sum }_{k} ℊ ( {y}_{k} ) ,$$

where x is the input representation at the iteration, yᵢ is the i-th latent vector in the assignment, c is the conditioning input, k indexes the latent vectors, d measures the independent component, f measures the pair-wise interactions and g measures higher-order interactions.

As will be described in more detail below, at each iteration of the iterative refinement, the system updates the estimate, i.e., modifies the input latent representation 230, based on pairwise interactions 232 and higher-order interactions 234.

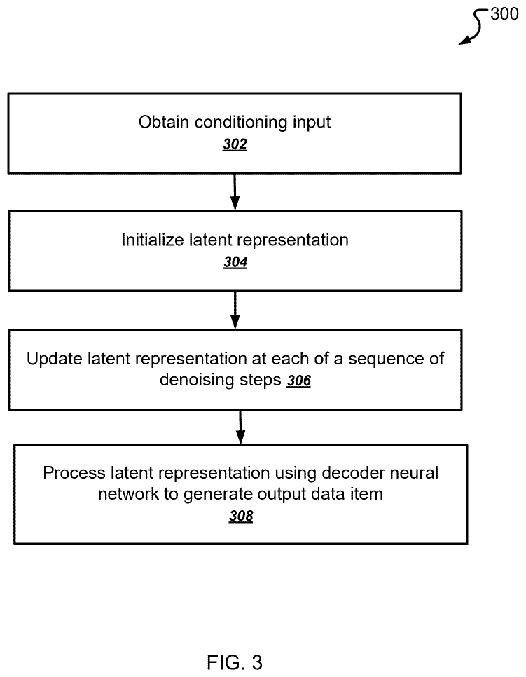

FIG. 3 is a flow diagram of an example process 300 for generating an output data item. For convenience, the process 300 will be described as being performed by a system of one or more computers located in one or more locations. For example, a data generation system, e.g., the data generation system 100 depicted in FIG. 1, appropriately programmed in accordance with this specification, can perform the process 300.

The system obtains a conditioning input characterizing a target data item (step 302).

The system initializes a latent representation of the target data item that includes a respective latent vector at each of a plurality of positions (step 304). For example, the system can sample each entry of each latent vector from a Gaussian distribution or another appropriate noise distribution.

The system updates the latent representation at each of a sequence of denoising steps (step 306).

At each of one or more particular denoising steps in the sequence, the system updates the latent representation at the particular denoising step by applying a latent continuous conditional random field (CRF) model to the latent representation.

As described above, the “particular” denoising steps can be all of the denoising steps in the sequence or can be a proper subset of the denoising steps in the sequence, i.e., can be less than all of the denoising steps in the sequence.

When the particular denoising steps are a proper subset of the denoising steps in the sequence, at each of the one or more other denoising steps in the sequence that are not part of the proper subset, the system updates the latent representation at the other denoising step by applying a latent diffusion model (LDM) to the latent representation as of the other denoising step.

After updating the latent representation of the target data item at each of the plurality of denoising steps, the system processes the latent representation using a decoder neural network to generate the target data item (step 308).

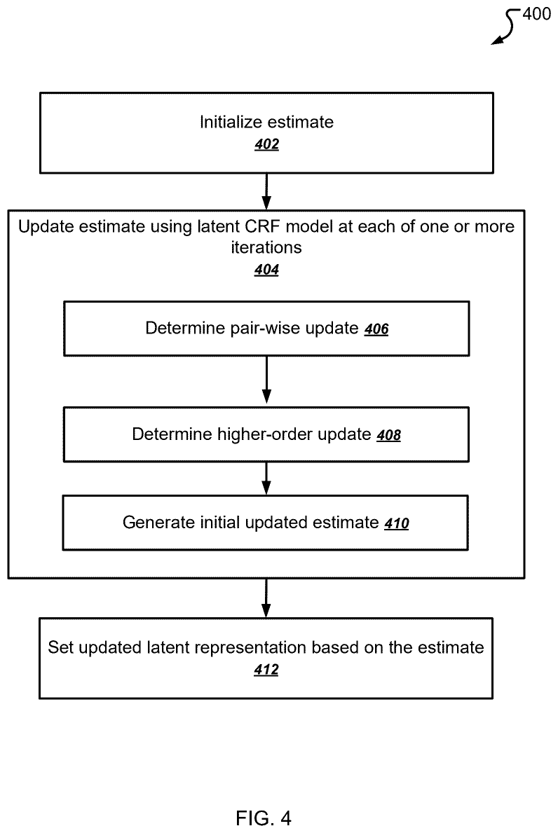

FIG. 4 is a flow diagram of an example process 400 for updating a latent representation at a particular denoising step using a latentCRF model. For convenience, the process 400 will be described as being performed by a system of one or more computers located in one or more locations. For example, a data generation system, e.g., the data generation system 100 depicted in FIG. 1, appropriately programmed in accordance with this specification, can perform the process 400.

The system initializes an estimate of a minimum latent representation to be equal to the latent representation as of the particular denoising step (step 402). As described above, the minimum latent representation is the representation that minimizes the energy given the latent representation as of the particular denoising step and the conditioning input.

At each of one or more iterations, the system then applies the latentCRF model to update the estimate of the minimum latent representation (step 404). That is, the system iteratively updates the estimate of the representation that minimizes the energy by performing these updates at each of the one or more iterations.

At each iteration, the system can perform steps 406-410 to update the estimate. The system determines a pair-wise update for the estimate (step 406). The pair-wise update is an update that decreases the pair-wise component of the energy of the estimate.

To determine the pair-wise update, the system can perform a message passing step on the estimate to determine an initial pair-wise update.

During the message passing step, each latent vector in the estimate is updated based on pair-wise weights between the position of the latent vector and other positions in the latent representation.

More specifically, the system performs the message passing step by, for each particular position of the positions in the latent representation, determining a latent vector at the particular position in the initial pair-wise update by computing a weighted sum of the latent vectors in the estimate.

In the weighted sum, each latent vector is weighted by a weight that is assigned to a respective pair of positions that includes the particular position and the position of the latent vector in the estimate. For example, the weight for each pair of positions can be learned during the training of the latentCRF model, i.e., so that, for each particular position, a respective weight is learned for each position in the latent representation.

After performing message passing, the system can apply a compatibility function to the initial pair-wise update and a representation of the conditioning input to generate the pair-wise update.

Generally, the compatibility function is a neural network that, for each position in the latent representation, processes, as input, the latent vector at the position in the initial pair-wise update and the representation of the conditioning input to generate the latent vector at the position in the pair-wise update. The neural network can generally have any appropriate architecture and can be trained as part of the training of the latentCRF model. For example, the neural network can be a multi-layer perceptron (MLP) or a self-attention neural network. For example, the pair-wise update for the i-th latent vector can be expressed as:

$${ϕ}_{{θ}_{a}} ( {\sum }_{i} {W}_{ij}^{s} {𝓎}_{j}^{( t )} ) ,$$

where ψ_{θ}_{_{O}} represents the compatibility function, the sum is over the latent vectors j,

$${W}_{i j}^{s}$$

is the weight value for the j-th latent vector in the weights for the i-th latent vector and

$${y}_{j}^{( t )}$$

is the j-th latent vector in the estimate.

The system determines a higher-order update for the estimate (step 408). The higher-order update is an update that decreases the higher-order component of the energy of the estimate. As described above, the higher-order component measures interactions within cliques of latent vectors that each include more than two latent vectors. To model this, the system makes use of one or more learned filters that are learned during the training of the latentCRF model and that can be convolved with an estimate to model higher-order interactions.

In particular, for each of the one or more learned filters, the system performs a convolution between the filter and the estimate to generate a convolved estimate. The system then applies an element-wise function to the convolved estimate to generate an activated convolved estimate. The element-wise function can be any appropriate non-linear element-wise function, e.g., the ReLU function, the tanh function, the sigmoid function, and so on.

The system then applies a mirror of the filter to the activated convolved estimate to generate an initial higher-order update for the filter. The “mirror” of a filter is a mirrored version of the filter generated by flipping the filter left-right and up-down around the center of the filter.

The system then combines, e.g., sums or averages and then optionally divides by a scalar, the initial higher-order updates for the filters to generate the higher-order update.

For example, the initial-higher order update for the i-th latent vector of the estimate can be:

$$\frac{1}{2} {\sum }_{m} {[ {J}_{m}^{-} ⊙ ω ( {J}_{m} ⊙ {y}^{( t )} ) ]}_{i}$$

where [Y]ᵢ represents the i-th component of a tensor Y, the sum is over m filters, Jₘ is the m-th filter, J_{m̅} is the mirror of the m-th filter, w is the element-wise function, ⊙ denotes convolution, and y^{(t)} is the estimate.

The system determines an initial updated estimate as a combination of the pair-wise update for the estimate, the higher-order update for the estimate, and the latent representation for the particular denoising step (step 410).

For example, the system can compute the initial updated estimate as a sum of the pair-wise update for the estimate, the higher-order update for the estimate, and the latent representation for the particular denoising step.

In some cases, the system uses the initial updated estimate as the updated estimate for the iteration.

In some other cases, the system further updates the initial updated estimate to generate the updated estimate. For example, the system can normalize the initial updated estimate by applying a learned normalization operation to the initial updated estimate. The learned normalization operation can be any appropriate learned normalization, e.g., batch normalization, layer normalization, and so on, and can be learned during the training of the latentCRF model.

After the last of the one or more iterations, the system sets the updated latent representation for the denoising step based on the estimate (step 412). For example, the system can set the updated latent representation for the denoising step to be the estimate after the last of the one or more iterations.

Thus, as can be seen from the description of the process 400, the latentCRF model has relatively few parameters and each iteration described above with respect to step 410 can be performed in a computationally efficient manner with minimal latency. For example, the latentCRF model can have at least ten times fewer parameters than the latent diffusion model described above.

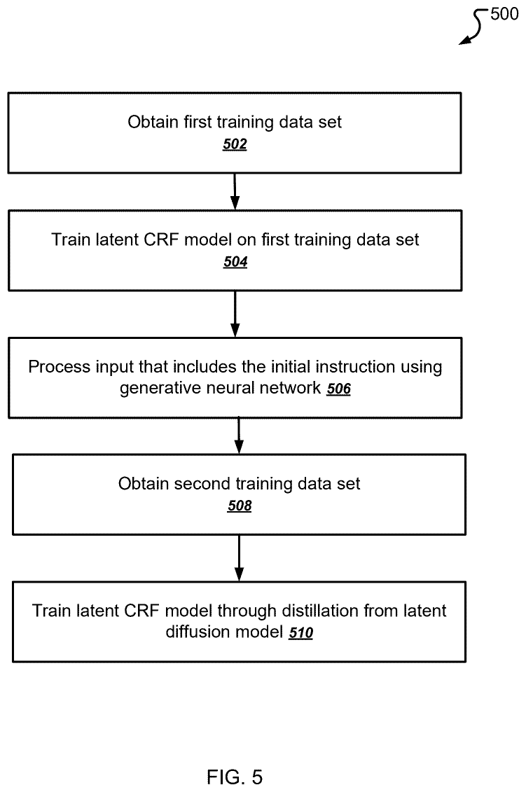

FIG. 5 is a flow diagram of an example process 500 for training the latentCRF model. For convenience, the process 500 will be described as being performed by a system of one or more computers located in one or more locations. For example, a data generation system, e.g., the data generation system 100 depicted in FIG. 1, appropriately programmed in accordance with this specification, can perform the process 500.

The system obtains a first training data set of training examples (step 502). Each training example in the first set includes a respective training data item and a respective conditioning input that describes the respective training data item.

The system trains the latentCRF model on the first set of training examples (step 504).

The system can train the latentCRF model on an objective that includes a denoising loss, an adversarial loss, or both.

The denoising objective measures, for each training example, a difference between (a) a latent representation of the respective training data item generated by processing the respective training data item using the encoder neural network described above and (b) an updated latent representation generated by the latentCRF model by processing the respective conditioning input and a noisy latent representation of the respective training data item. For example, the objective can be the L2 norm, the mean squared error, or any other appropriate difference measure. The system can generate the noisy latent representation by sampling noise from the noise distribution described above and performing a weighted sum between the sampled noise and the latent representation of the respective training data item.

For example, the denoising objective can be:

$${ℒ}_{NT} = {‖ 𝓏 - ℳ ( \tilde{𝓏} ) ‖}_{2} ,$$

where M represents the operations of the latentCRF model, z is the latent representation of the respective training data item and \tilde{z} is the noisy latent representation.

The adversarial loss measures, for each training example, the output of a discriminator neural network, e.g., a convolutional neural network or vision Transformer neural network, generated by processing the latent representation generated by the latentCRF model by processing the respective conditioning input and a noisy latent representation of the respective training data item. The discriminator output generally measures the likelihood, as predicted by the discriminator neural network, that the input processed by the discriminator neural network is a latent representation for a data item drawn from the first training data set of training examples rather than an updated estimate generated by the latentCRF model. The system trains the discriminator neural network jointly with the latentCRF model on an objective that encourages the discriminator neural network to accurately distinguish between latent representations for data items drawn from the first training data and updated estimates generated by the latentCRF model.

The system can generally use any appropriate generative adversarial network (GAN) objective for the adversarial loss and the discriminator training loss. As one example, the objective can be:

$${ℒ}_{SCE} ( a , t ) = max ( a , 0 ) - a \cdot t + log ( 1 + exp ( - abs ( a ) ) )$$

where t indicates whether the input to the discriminator is a latent representation for a data item drawn from the first training data set of training examples or an updated estimate generated by the latentCRF model and a is the output of the discriminator.

When the objective includes both the adversarial and denoising losses, the overall objective for training the latentCRF model can be a sum or a weighted sum of the adversarial and denoising losses.

When the latentCRF model will be used to improve the computational efficiency of generating data items using a latent diffusion model after training, the system can further train the latentCRF model to align with the latent diffusion model.

In these cases, the system obtains a second training data set of training examples (step 506). Each training example in the second set includes a respective conditioning input, but need not include a training data item. For example, the second set of training examples can include all or a subset of the conditioning inputs from the training examples in the first set or can be a different set of training examples.

The system then trains the latent CRF model on the second training data set on a distillation objective generated using a pre-trained latent diffusion model (step 508). Generally, the pre-trained latent diffusion model is the latent diffusion model that will be used in conjunction with the latentCRF model at inference and can have any of the architectures described above.

Given a conditioning input, the system can use the LDM to iteratively denoise a latent representation of a corresponding data item. The system then uses the latent representation zₛ output by the LDM at an intermediate denoising step s and the final latent representation z_{f} after the final denoising step f to train the latentCRF model. For example, the distillation objective can measure, for each training example, a difference between (a) the final latent representation z_{f} and (b) an updated latent representation generated by the latentCRF model by processing the respective conditioning input and the intermediate latent representation zₛ. For example, the objective can be the L2 norm, the mean squared error, or any other appropriate difference measure.

For example, the distillation objective can be:

$${ℒ}_{DT} = {‖ {𝓏}_{f} - ℳ ( {𝓏}_{s} ) ‖}_{2} ,$$

where M represents the operations of the latentCRF model.

Thus, the system trains the latentCRF model to accurately predict z_{f} given zₛ and the conditioning input, allowing the system to bypass one or more denoising steps after the intermediate denoising step s by making use of the latentCRF model at inference.

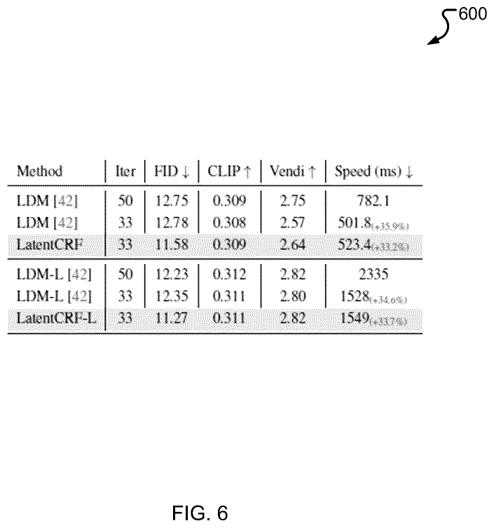

FIG. 6 shows an example 600 of the performance of the described techniques. In particular, the example 600 compares two variants of the described techniques (LatentCRF and LatentCRF-L, with the “L” variant having more parameters than the LatentCRF variant) when used to augment a latent diffusion model (LDM) relative to using only the LDM to generate images conditioned on text inputs. As can be seen from the example 600, introducing either LatentCRF variant improves both generated image quality and inference speed, with no or minimal diversity losses.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently. Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a conditioning input characterizing a target data item;
initializing a latent representation of the target data item that comprises a respective latent vector at each of a plurality of positions;
updating the latent representation at each of a sequence of denoising steps, comprising, at each of one or more particular denoising steps in the sequence, updating the latent representation at the particular denoising step by applying a latent continuous conditional random field (CRF) model to the latent representation; and
after updating the latent representation of the target data item at each of the plurality of denoising steps, processing the latent representation using a decoder neural network to generate the target data item.

2. The method of claim 1, wherein initializing the latent representation of the target data item comprises sampling at least some of the values in the respective latent vectors from a noise distribution.

3. The method of claim 1, wherein the target data item is an image, a video, or an audio sample.

4. The method of claim 1, wherein the conditioning input comprises one or more of:
text,
an image,
a video, or
an audio sample.

5. The method of claim 1, wherein the sequence of denoising steps comprises the one or more particular denoising steps and one or more other denoising steps, and wherein updating the latent representation comprises, at each of the one or more other denoising steps in the sequence, updating the latent representation at the other denoising step by applying a latent diffusion model (LDM) to the latent representation.

6. The method of claim 5, wherein the other denoising steps in the sequence comprise:
a first set of other denoising steps that precede the one or more particular denoising steps in the sequence.

7. The method of claim 6, wherein the other denoising steps in the sequence comprise:
a second set of other denoising steps that follow the one or more particular denoising steps in the sequence.

8. The method of claim 1, wherein applying a latent continuous conditional random field (CRF) model to the latent representation comprises applying the latentCRF model to determine an estimate of an updated latent representation that minimizes an energy function given the latent representation as of the particular denoising step.

9. The method of claim 8, wherein the energy function measures a respective unary energy of each latent vector in the given candidate latent updated representation given a corresponding latent vector in a same position in the latent representation as of the particular denoising step.

10. The method of claim 8, wherein the energy function measures, for each of a plurality of pairs that each include a respective latent vector from the candidate updated latent representation and a respective latent vector in the latent representation as of the particular denoising step, a respective pairwise energy arising from an interaction between the latent vectors in the pair given the conditioning input.

11. The method of claim 8, wherein the energy function measures a respective higher-order energy for each of a plurality of patches of latent vectors from the given candidate latent updated representation.

12. The method of claim 1, wherein updating the latent representation at the particular denoising step by applying a latent continuous conditional random field (CRF) model to the latent representation comprises:
initializing an estimate of a minimum latent representation to be equal to the latent representation as of the particular denoising step; and
at each of one or more iterations, applying the latentCRF model to the estimate to update the estimate; and
after the last of the one or more iterations, setting the updated latent representation for the denoising step based on the estimate.

13. The method of claim 12, wherein applying the latentCRF model to update the estimate comprises:
determining a pair-wise update for the estimate;
determining a higher-order update for the estimate; and
determining an initial updated estimate as a combination of the pair-wise update for the estimate, the higher-order update for the estimate, and the latent representation for the particular denoising step.

14. The method of claim 13, wherein the initial updated estimate is a sum of the pair-wise update for the estimate, the higher-order update for the estimate, and the latent representation for the particular denoising step.

15. The method of claim 13, wherein applying the latentCRF model to update the estimate further comprises:
normalizing the initial updated estimate.

16. The method of claim 15, wherein normalizing the initial updated estimate comprises applying a learned normalization operation to the initial updated estimate.

17. The method of claim 13, wherein determining a pair-wise update for the estimate comprises:
performing a message passing step on the estimate to determine an initial pair-wise update; and
applying a compatibility function to the initial pair-wise update and a representation of the conditioning input to generate the pair-wise update.

18. The method of claim 17, wherein the compatibility function is a neural network that, for each position, processes, as input, the latent vector at the position in the initial pair-wise update and the representation of the conditioning input to generate the latent vector at the position in the pair-wise update.

19. The method of claim 17, wherein performing the message passing step comprises, for each particular position of the positions in the latent representation, determining a latent vector at the particular position in the initial pair-wise update by computing a weighted sum of the latent vectors in the estimate, wherein each latent vector is weighted by a weight that is assigned to a respective pair of positions that includes the particular position and the position of the latent vector in the estimate.

20. The method of claim 13, wherein determining a higher-order update for the estimate comprises:
for each of a plurality of learned filters:
performing a convolution between the filter and the estimate to generate a convolved estimate;
applying an element-wise function to the convolved estimate to generate an activated convolved estimate; and
applying a mirror of the filter to the activated convolved estimate to generate an initial higher-order update for the filter; and
combining the initial higher-order updates for the filters to generate the higher-order update.

21. The method of claim 1, wherein the latent continuous conditional random field (CRF) model has been trained on a first training data set that comprises a plurality of training examples, each training example comprising (i) a conditioning input and (ii) a training data item characterized by the conditioning input.

22. The method of claim 1, wherein the latentCRF model has been trained on an objective that includes a denoising loss.

23. The method of claim 22, wherein the objective further includes an adversarial loss.

24. The method of claim 21, wherein, after being trained on the first training data set, the latentCRF model has been trained on a second data set on a distillation objective generated using a pre-trained latent diffusion model.

25. A system comprising:
one or more computers; and
one or more storage devices storing instructions that, when executed by the one or more computers, cause the one or more computers to perform operations comprising:
obtaining a conditioning input characterizing a target data item;
initializing a latent representation of the target data item that comprises a respective latent vector at each of a plurality of positions;
updating the latent representation at each of a sequence of denoising steps, comprising, at each of one or more particular denoising steps in the sequence, updating the latent representation at the particular denoising step by applying a latent continuous conditional random field (CRF) model to the latent representation; and
after updating the latent representation of the target data item at each of the plurality of denoising steps, processing the latent representation using a decoder neural network to generate the target data item.

26. One or more computer-readable storage media storing instructions that when executed by one or more computers cause the one or more computers to perform operations comprising:
obtaining a conditioning input characterizing a target data item;
initializing a latent representation of the target data item that comprises a respective latent vector at each of a plurality of positions;
updating the latent representation at each of a sequence of denoising steps, comprising, at each of one or more particular denoising steps in the sequence, updating the latent representation at the particular denoising step by applying a latent continuous conditional random field (CRF) model to the latent representation; and
after updating the latent representation of the target data item at each of the plurality of denoising steps, processing the latent representation using a decoder neural network to generate the target data item.
